(19) United States
(12) Patent Application Publication
(10) Pub. No.: US 2014/0238792 A1
(43) Pub. Date: Aug. 28, 2014

(54) COOLING DEVICE FOR A RIM AND A BRAKING SYSTEM

(71) Applicant: Wayne-Ian Moore, CHANGHUA COUNTY (TW)

(72) Inventor: Wayne-Ian Moore, CHANGHUA COUNTY (TW)

(21) Appl. No.: 13/781,673

(22) Filed: Feb. 28, 2013

(51) Int. Cl. F16D 65/847

(52) U.S. Cl. CPC F16D 65/847
USPC 188/264 A

(57) ABSTRACT

A cooling device for a rim and a braking system includes a blower set having a frame and two blowers, the frame assembled onto a fork of a bicycle, the two blowers both assembled onto the frame at one side of a rim member, each blower having an air inlet, a receiving room, a fan, an air outlet and a switch unit, the fan rotatably assembled in the receiving room, the receiving room communicating with the air inlet and the air outlet, the switch unit electrically connected to the fan, the air outlet of one blower corresponding to a braking member of the bicycle, the air outlet of another blower corresponding to the rim member.

### BACKGROUND OF THE INVENTION

1. Field of the Invention

The present invention relates to a cooling device, and more particularly to a cooling device for a rim and a braking system.

2. Description of Related Art

Bicycles are very popular today. When a rider rides a bicycle along a downhill, a braking system ensures the safety for the rider. Recently, the braking system is driven by a hydraulic system or a cable system which drives two clamping plates in the braking system to clamp a rim of a wheel, so as to slow down a rotational speed of each wheel of the bicycle. In addition, when the rider rides along the downhill, the rider needs to frequently brake the bicycle because of safety; as a result, the two clamping plates of the braking system and the rim of the wheel would be overheated because of said frequently braking. Therefore, both each clamping plate and the rim would be deformed because of said overheating, so that a frictional efficiency between each clamping plate and the rim would be further reduced.

In addition, after raining, there is a lot of rainwater accumulated on a bumpy road. When the rider rides through the bumpy road, the rainwater on the bumpy road would be splashed on the rim of the wheel so that the rim would be wetted. Therefore, the frictional efficiency between each clamping plate and the rim would be further reduced because of wetting the rim.

The present invention has arisen to mitigate and/or obviate the disadvantages of the conventional braking system.

### SUMMARY OF THE INVENTION

The main objective of the present invention is to provide an improved cooling device.

To achieve the objective, a cooling device for a rim and a braking system, which is assembled onto a bicycle, comprises a blower set having a frame and two blowers, the frame assembled onto a fork of the bicycle, the two blowers both assembled onto the frame at one side of a rim member, each blower having an air inlet, a receiving room, a fan, an air outlet and a switch unit, the fan rotatably assembled in the receiving room, the receiving room communicating with the air inlet and the air outlet, the switch unit electrically connected to the fan so as to start the fan of each blower, the air outlet of one blower corresponding to a braking member of the bicycle, the air outlet of another blower corresponding to the rim member. Wherein, a further blower set is further assembled at another side of the rim member, so that the further blower set is symmetrical to the blower set; when the bicycle is driven frontward, the rim member rotates relative to the air outlet of another blower; a switch member is further assembled at a handlebar; the switch member is electrically connected to the switch unit of each blower via an electric wire; the switch member has a starter and a switch plate; one end of the starter faces the handlebar; another end of the starter faces a brake lever; one end of the switch plate is pivoted on another end of the starter; a switch detector is further assembled at a handlebar; the switch detector is wirelessly connected to the switch unit of each blower; said wireless connection might be performed as an infrared connection, a WIFI connection or a Bluetooth connection.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a cooling device for a rim and a braking system of the present invention;

FIG. 2 is a perspective view for showing a further blower set;

FIG. 3 is a perspective view for showing a blower;

FIG. 4 is a block chart for showing a connection between a switch device and the blower; and

FIGS. 5-6 are perspective views for showing a braking member which is further defined as a hydraulic braking member.

### DETAILED DESCRIPTION OF THE INVENTION

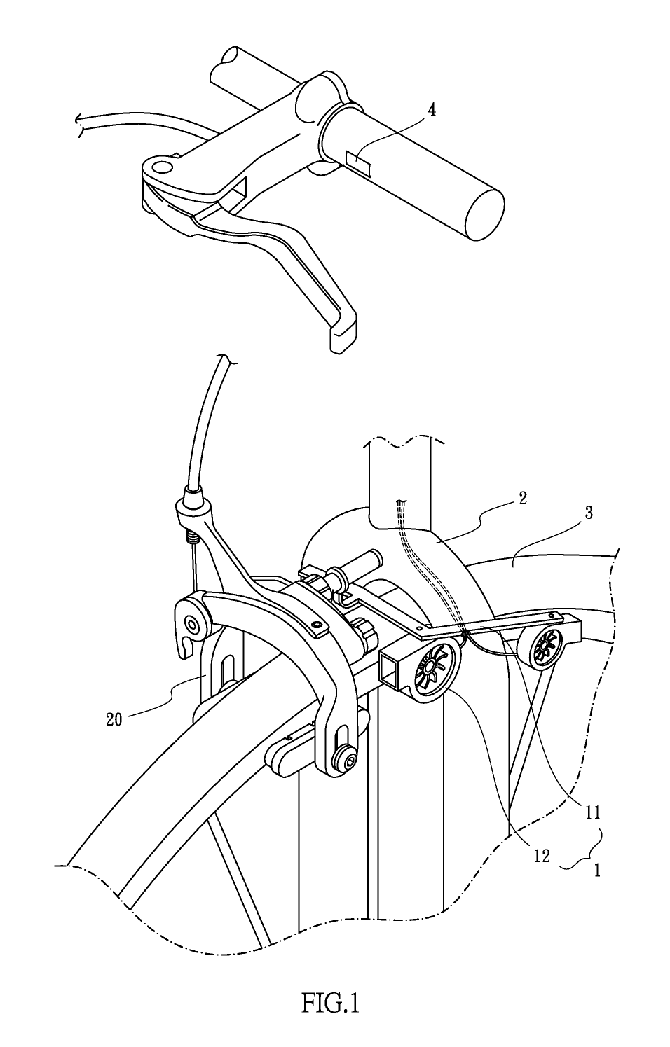

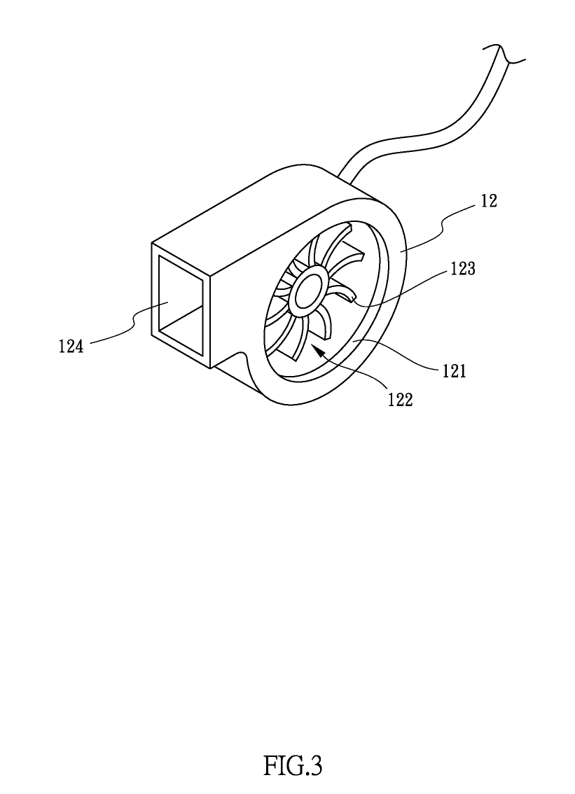

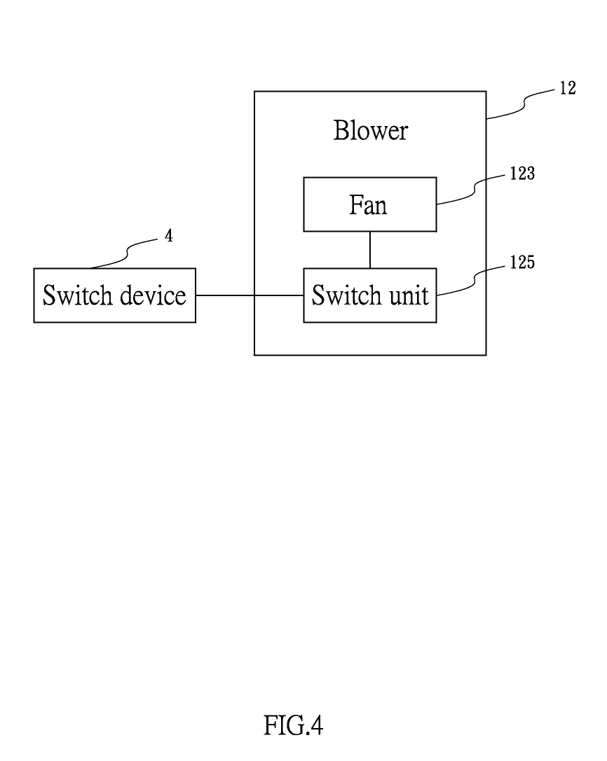

Referring to FIGS. 1-4, a cooling device for a rim and a braking system in accordance with the present invention is assembled onto a bicycle (not shown). The cooling device for a rim and a braking system comprises a blower set 1. The blower set 1 has a frame 11 and two blowers 12. The frame 11 is assembled onto a fork 2 of the bicycle. The two blowers 12 are both assembled onto the frame 11 at one side of a rim member 3. The two blowers 12 are respectively located at two sides of the fork 2. Each blower 12 has an air inlet 121, a receiving room 122, a fan 123, an air outlet 124 and a switch unit 125. The fan 123 is rotatably assembled in the receiving room 122. The receiving room 122 communicates with the air inlet 121 and the air outlet 124. The switch unit 125 is electrically connected to the fan 123 so as to start the fan 123 of each blower 12. The air outlet 124 of one blower 12 corresponds to a braking member 20 of the bicycle. The air outlet 124 of another blower 12 corresponds to the rim member 3, so that when the bicycle is driven frontward, the rim member 3 rotates relative to the air outlet 124 of another blower 12; consequently, another blower 12 blows the rim member 3 directly.

Under this arrangement, when the switch unit 125 starts the fan 123 of each blower 12, ambient air around each blower 12 flows toward the air inlet 121 of each blower 12; thereafter, the ambient air flowing toward the air inlet 121 further flows into the receiving room 122 of each blower 12 via the air inlet 121; finally, the ambient air in the receiving room 122 further flows to an outside relative to each blower 12 via the air outlet 124 of each blower 12; as a result, one blower 12 blows the braking member 20 and another blower 12 blows the rim member 3. Therefore, the blower set 1 of the present invention can not only cool the braking member 20 and the rim member 3 of the bicycle during braking, but also dry the rim member 3 if the rim member 3 has been wetted.

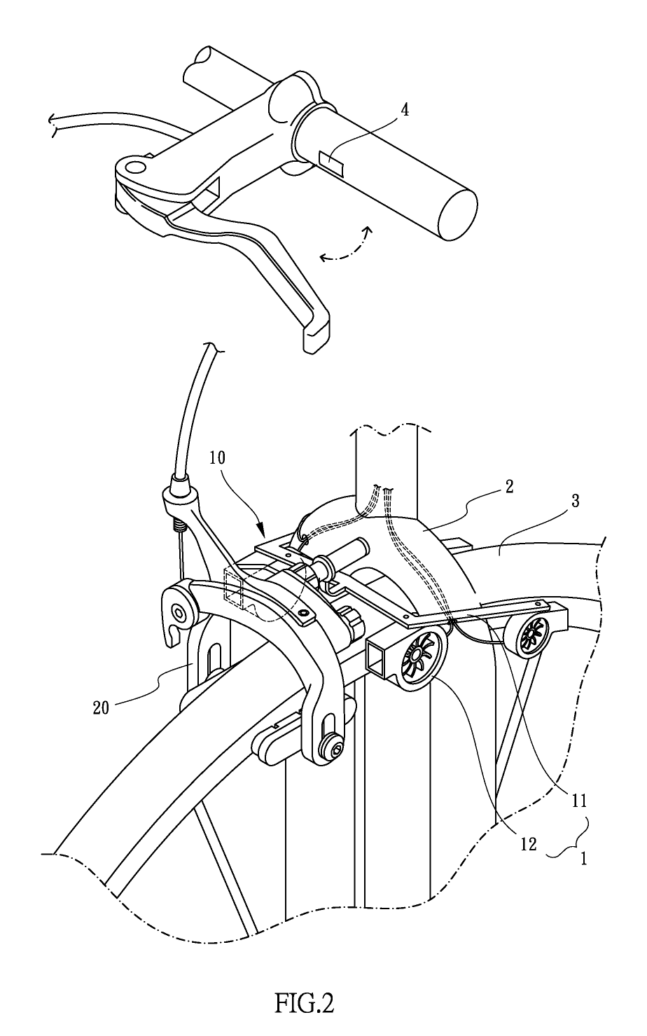

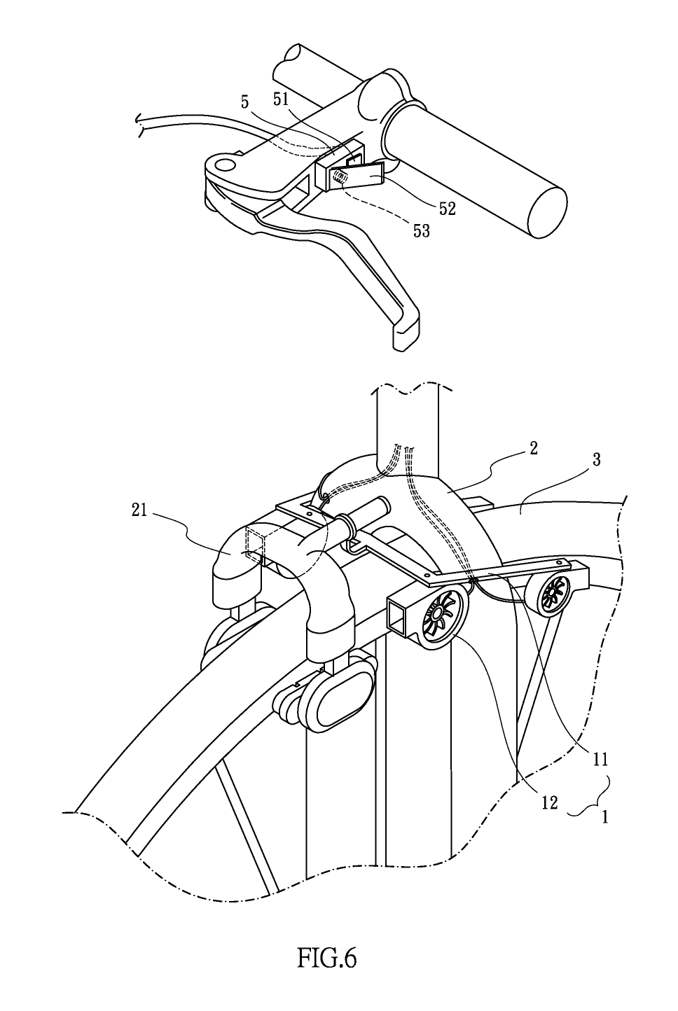

Referring to FIGS. 2 and 6, a further blower set 10 is further assembled at another side of the rim member 3, so that the further blower set 10 is symmetrical to the blower set 1.

The cooling device for a rim and a braking system further comprises a switch device which is assembled at a handlebar (as shown in FIGS. 1-2 and 4 or FIGS. 5-6). Referring to FIGS. 1-2 and 4, the switch device is defined as a switch detector 4. The switch detector 4 is electrically connected to the switch unit 125 of each blower 12 via an electric wire (not shown), or is wirelessly connected to the switch unit 125 of each blower 12. Said wireless connection might be performed as an infrared connection, a WIFI connection or a Bluetooth connection. The switch detector 4 is used to detect a motion of a brake lever (as shown in FIGS. 1-2). Under this arrangement, when a rider pulls the brake lever to operate the braking member 20, the switch detector 4 at the handlebar detects the motion of the brake lever; as a result, the switch detector 4 starts the fan 123 of each blower 12 because of said detection.

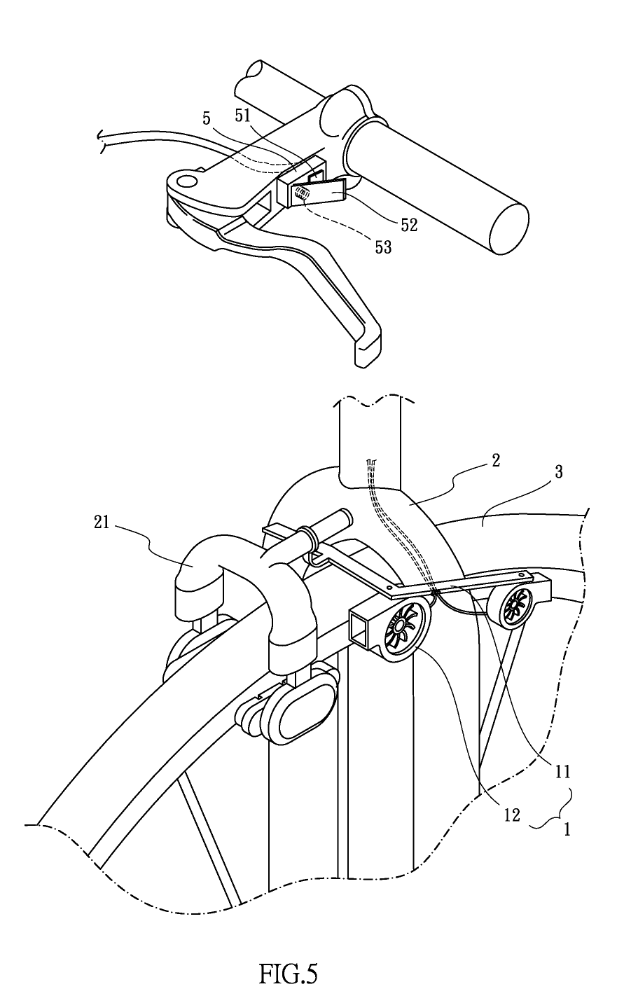

Referring to FIGS. 5-6, the switch device is defined as a switch member 5. The switch member 5 has a starter 51 and a switch plate 52. One end of the starter 51 faces the handlebar. Another end of the starter 51 faces a brake lever (as shown in FIGS. 5-6). One end of the switch plate 52 is pivoted on another end of the starter 51. A spring 53 is assembled between the starter 51 and the switch plate 52. The starter 51 is electrically connected to the switch unit 125 of each blower 12 via an electric wire (not shown), or is wirelessly connected to the switch unit 125 of each blower 12, so as to start the fan 123 of each blower 12. Said wireless connection might be performed as an infrared connection, a WIFI connection or a Bluetooth connection. Under this arrangement, when the rider pulls the brake lever to operate the braking member 20, the switch plate 52 is smoothly pressed by the brake lever; as a result, the starter 51 starts the fan 123 of each blower 12 by said press.

Furthermore, the braking member 20 might be operated via a braking cable (as shown in FIGS. 1-2). Referring to FIGS. 5-6, the braking member 20 might be further defined as a hydraulic braking member 21 which is operated via a hydraulic method.

Although the invention has been explained in relation to its preferred embodiment, it is to be understood that many other possible modifications and variations can be made without departing from the spirit and scope of the invention as hereinafter claimed.

What is claimed is:

1. A cooling device for a rim and a braking system, which is assembled onto a bicycle, comprising:
a blower set having a frame and two blowers, the frame assembled onto a fork of the bicycle, the two blowers both assembled onto the frame at one side of a rim member, each blower having an air inlet, a receiving room, a fan, an air outlet and a switch unit, the fan rotatably assembled in the receiving room, the receiving room communicating with the air inlet and the air outlet, the switch unit electrically connected to the fan so as to start the fan of each blower, the air outlet of one blower corresponding to a braking member of the bicycle, the air outlet of another blower corresponding to the rim member.

2. The cooling device for a rim and a braking system as claimed in claim 1, wherein a further blower set is further assembled at another side of the rim member, so that the further blower set is symmetrical to the blower set.

3. The cooling device for a rim and a braking system as claimed in claim 1, wherein when the bicycle is driven frontward, the rim member rotates relative to the air outlet of another blower.

4. The cooling device for a rim and a braking system as claimed in claim 1, wherein a switch member is further assembled at a handlebar; the switch member is electrically connected to the switch unit of each blower via an electric wire.

5. The cooling device for a rim and a braking system as claimed in claim 4, wherein the switch member has a starter and a switch plate; one end of the starter faces the handlebar; another end of the starter faces a brake lever; one end of the switch plate is pivoted on another end of the starter.

6. The cooling device for a rim and a braking system as claimed in claim 1, wherein a switch detector is further assembled at a handlebar; the switch detector is wirelessly connected to the switch unit of each blower.

7. The cooling device for a rim and a braking system as claimed in claim 6, wherein said wireless connection might be performed as an infrared connection, a WIFI connection or a Bluetooth connection.
